(19) United States
(12) Patent Application Publication
(10) Pub. No.: US 2019/0390649 A1
(43) Pub. Date: Dec. 26, 2019

(54) WIND TURBINE

(71) Applicant: Jan WISNIEWSKI, Modzelewskiego (PL)

(72) Inventor: Jan WISNIEWSKI, Modzelewskiego (PL)

(21) Appl. No.: 16/334,757

(22) PCT Filed: Sep. 19, 2017
(86) PCT No.: PCT/PL2017/000087

§ 371 Date: Mar. 20, 2019

(30) Foreign Application Priority Data
Sep. 23, 2016 (PL) 418807

(51) Int. Cl. F03D 3/00; F03D 3/06; F03D 3/02

(52) U.S. Cl. CPC F03D 3/005; F05B 2240/214; F03D 3/02; F03D 3/061

(57) ABSTRACT

Turbine consists of several assemblies/2, 4/of the wings/3,5/of different diameters/d,D₁/depending on their placement, with the diameter/D₁/at half of the length of the wings/5/of the assembly/4/located higher of at least 1.05 of the diameter/d/at half of the length of the lowest assembly/2/of the blades/3/.

The chords/C₁/of profiles of the wings/5/at half of the length of these wings/5/of the upper assembly/4/are from 1.02 to 1.7 of the chords/c/of the wings/3/at half of their length/3/of the assembly/2/at the bottom.

The wedging angle of the wings is from 1 to 9 degrees.

The parts of the aerodynamic biconvex wings on the inner and outer sides of the chord line are different.

The presented invention relates to a wind turbine with a vertical rotation axis of the main shaft.

Such turbines usually have one or more wing assemblies located on the main vertical shaft of the power station, shifted relative to each other by a fixed or changing angle.

“Vertical axis wind turbine wing and its wind rotor” described in the patent US 20120201687 A1 is a single-level wind turbine, characterized by the fact that the cross sections of its wings are aerodynamic profiles and that the wings are curved in such a way that there is an angular deviation between the upper and the lower end of each wing.

Another solution described in the patent UK 2463957-A, “Multiple rotor vertical axis wind turbine”, refers to a structure with a large number of generators to which a number of independent rotors are connected, each moving separately from each other.

The solution included in the Polish patent application No. PL 396608 “Wind turbine with vertical axis of rotation with rotor divided into independently moving segments” refers to a multi-level wind turbine characterized by the fact that its individual rotors are moving separately from each other and are not shifted by a fixed angle during work—their speed and position are continuously controlled by control systems. The application was rejected due to similarities to application No. UK 2463957-A.

The application No. WO 2016/030821 A1, “Three-vane double rotor for vertical axis wind turbine”, refers to a three-wing, drag-type double rotor wind turbine characterized by a 100% blockage ratio, with parts separated by a horizontal plate and each part being of the same height, and the application No. WO 2013/046011 A2 “Turbine for the production of electric energy”, refers to a gas or liquid drag-type turbine, consisting of shafts divided by horizontal plates fitted with curved tiles that change their angle of deviation with respect to shafts and that are consistent in height.

Today, all industrial wind turbines are horizontal axis wind turbines (HAWT). The attempts to produce a large-scale vertical axis wind turbine (VAWT) which is often presented as a cheaper, more effective alternative with additional pro-social benefits so far have not been successful due to significant problems such as the upper values of the bending moments during the operating cycle of the vertical axis wind turbine and the amplitude of these values translating into a decrease in the service life of the structure due to the fatigue of its critical components.

Both phenomena lead to a significant reduction in the durability of the power station, which is manifested by very rapid damage to its foundation or damage to the structure, which results in decisions on the lack of economic justification for erecting objects with such a limited lifespan, despite their numerous advantages. Sometimes, this problem is solved in part by creating a massive structure to increase the strength of the structure, but this process, on an industrial scale, is insufficient for the planned operating life of the plant and, at the same time, costly due to the increase in the materials required.

The wind turbine according to the invention is characterized in that the diameters of the wing assemblies change along with the increase in the height of their placement in such a way that the diameter in the mid-length of each of the above-positioned wings assembly is at least 1.05 of the diameter at half the length of the lowest wing assembly depending on the wind velocity gradient.

In addition, the assemblies located above have greater chord lengths at half of the length of the wings than the wings of the lower assembly. These chord lengths at mid-length of the wings of the upper assembly are from 1.02 of the chord length at mid-length of the wings of the lower assembly to 1.7 of the chord length at mid-length of the wings of the lower assembly, preferably from 1.1 to 1.3 of the chord length at mid-length of the wings in the lower assembly. The wing wedging angle—the angle at which the wing is attached in relation to the direction of the wing movement, is from 1 to 9 degrees, preferably 2 to 5 degrees.

The width of the sections of the aerodynamic biconvex wing profiles on the inner side of the chord line are from 1.05 to 2.0 of the width the sections of the aerodynamic biconvex wing profiles on the outer side of the chord line, preferably from 1.3 to 1.7 of the width of those aerodynamic biconvex wing profiles located on the outside of the chord line.

The term “wind turbine” is used to describe wind power stations designed to operate at a linear speed of movement of the wings which is higher than the speed of the incoming undistorted wind in order to distinguish them from the drag-type wind power stations such as the Savonius windmill.

“The wedging angle” determines the angle between the chord of the aerodynamic profile which at a given point is a section of the fixed wing and a tangent to the circumference of the wing path of the wind turbine. Positive angles were assumed for the deviation of the profile nose outside of the axis of the wing movement.

Such design improves the aerodynamic efficiency of the system.

For high Reynolds numbers, which correspond to the working conditions of a structure with a height greater than several meters, the optimal wing specific speed rate, calculated as the ratio of the speed of the wing in relation to undisturbed wind speed at a given altitude, remains almost unchanged. At the same time as the altitude increases, the predicted wind speed changes. This means that in order to maintain the same specific speed rate predicted during operation along the height, an increase in the angular velocity of the sections of the wings with the height is required, or, as postulated in the submitted solution, an increase in the diameter of the assemblies corresponding to the predicted wind velocity gradient along with the changing height.

Additional efficiency gains can be achieved by adjusting the chord length of the wing cross section to the diameter. This effect does not have to be uniform, especially at the wing tips, where, especially in the optimization of the aircraft wings, it is common to reduce the chord near the tip to limit the production of induced vortices.

For the precisely chosen specific speed ranges and Reynolds numbers, it is possible to achieve aerodynamic performance, using profiles which are non-symmetrical and convex on both sides, that will be higher than when using the symmetrical NACA profiles commonly considered to be the most efficient. An asymmetrical profile, installed within the desired range of angles, must have a narrower side outside the axis of movement of the wing.

A simplified image of wind speed changes with height can be found in Polish Norm No. PN-77 B-02011, However, there are two more accurate equations for calculating the change of wind speed with height, the logarithmic equation and a power law equation, both of which can be found in a number of slightly different variants.

### Logarithmic Equation:

$${V}_{2} = {V}_{1} \cdot ( \frac{\frac{{h}_{2}}{{z}_{0}}}{\frac{{h}_{1}}{{z}_{0}}} ) ,$$

where
V₁—wind speed at height h₁
V₂—wind speed at height h₂
z₀—roughness length of a given ground
Power law equation:

$${V}_{2} = {V}_{1} \cdot {( \frac{{h}_{2}}{{h}_{1}} )}^{α} ,$$

where
v₁—wind speed at height h₁
v₂—wind speed at height h₂
α—Hellmann exponent for the given ground

For the range of high Reynolds numbers, an optimum ratio of the speed of movement of the section of the wing in relation to wind speed can be distinguished for a specific aerodynamic profile. The simplest way to maintain optimum parameters for the majority or the entirety of the wing, and not just for a single point or number of points, is to adjust the diameter of the rotor along with the height which will allow the rotor section moving at the specified angular velocity located on the longer radius to move faster.

The above optimization may not reflect the momentary nature of speed changes along with height in an ideal fashion, but in the long run it will do it much more accurately than a rotor that would not expand in accordance with a generalized gradient of wind.

The adopted principle should, if necessary, take into account some minor changes—the rotor will be the narrowest near the base, i.e. the sections of the wings at low height will be closest to the tower of the turbine. The tower itself should not become proportionally narrower—for reasons of strength it may even expand in width, so by applying this method without corrections one could observe a growing adverse impact of tower interference on the flow around the profiles near the base of the wind turbine. Depending on the parameters such as rotor diameter, tower diameter and chord of the profile of the wind at the given height, as well as the climate conditions for which a particular model of the turbine will be designed, it may be beneficial to refine the character of the narrowing of the rotor near its base.

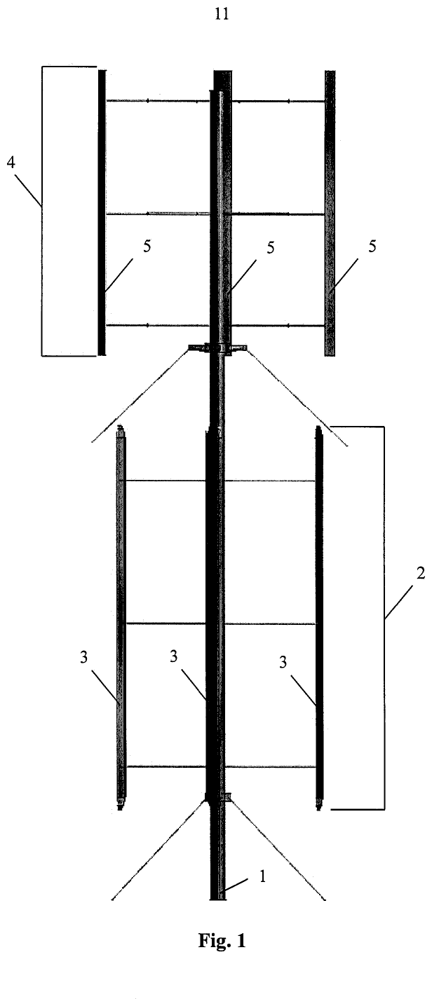

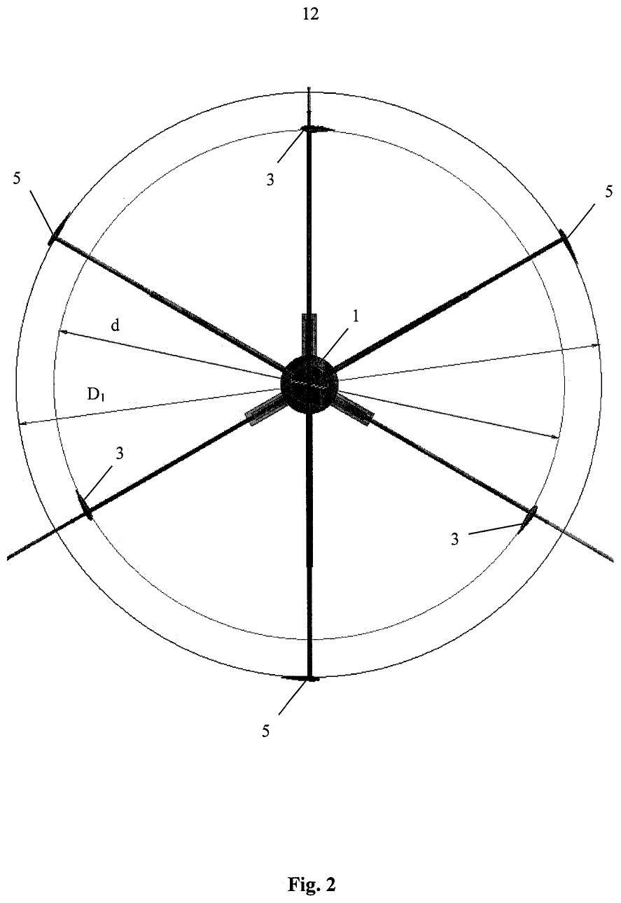

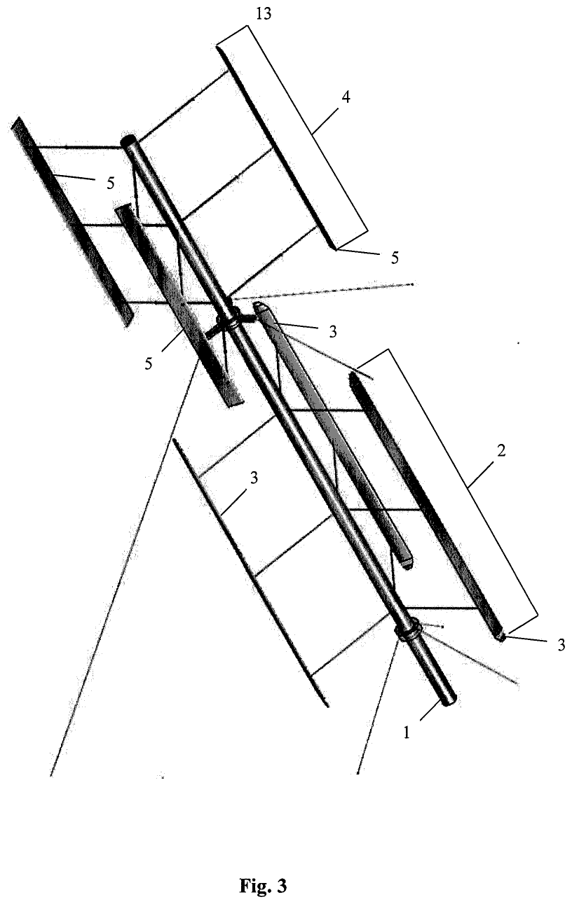

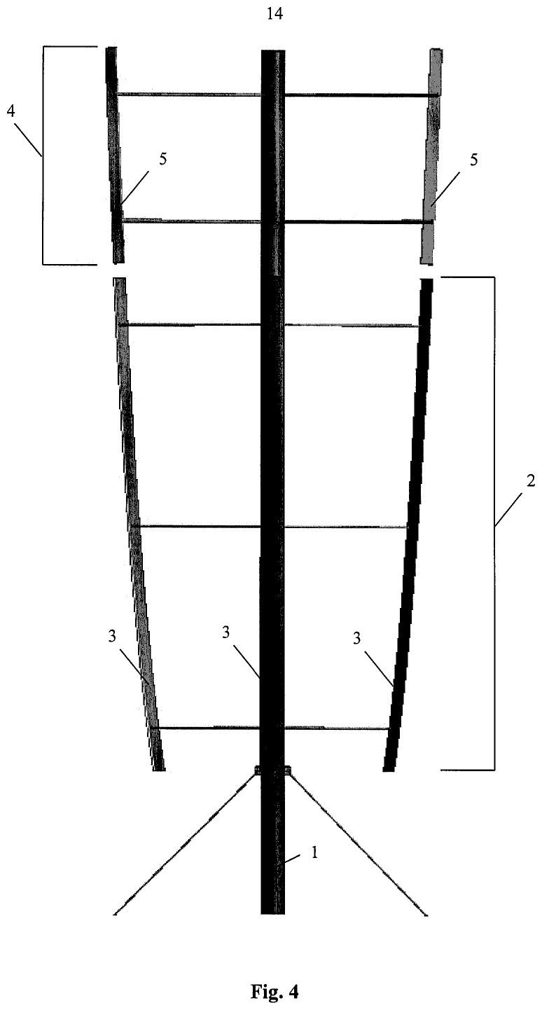

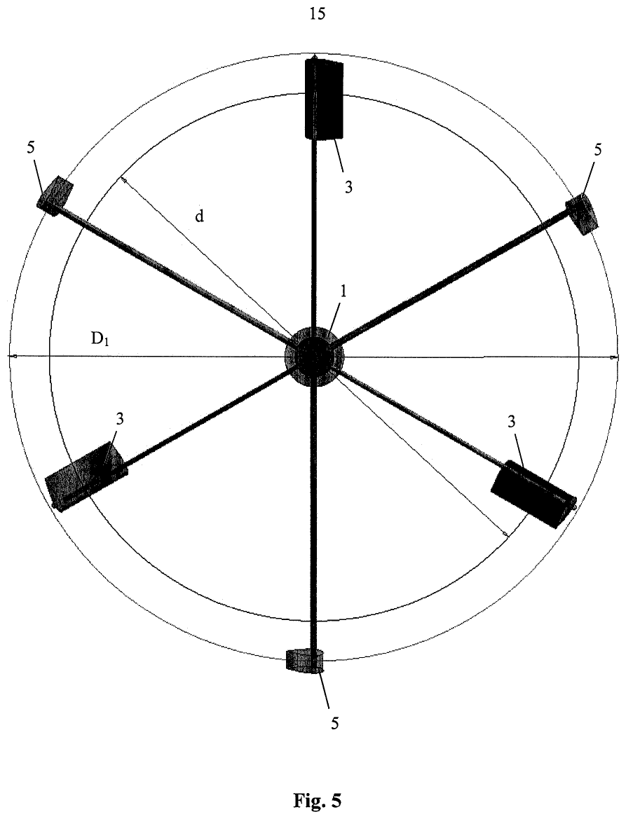

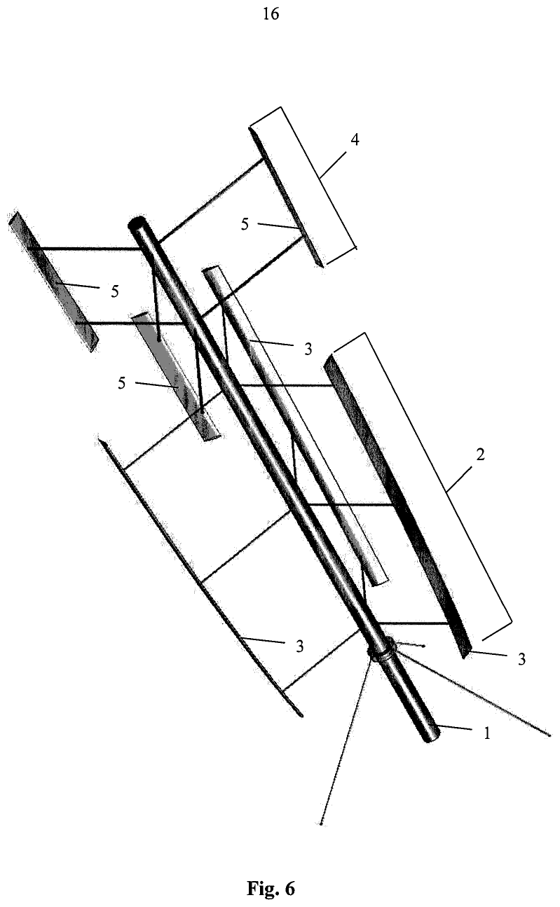

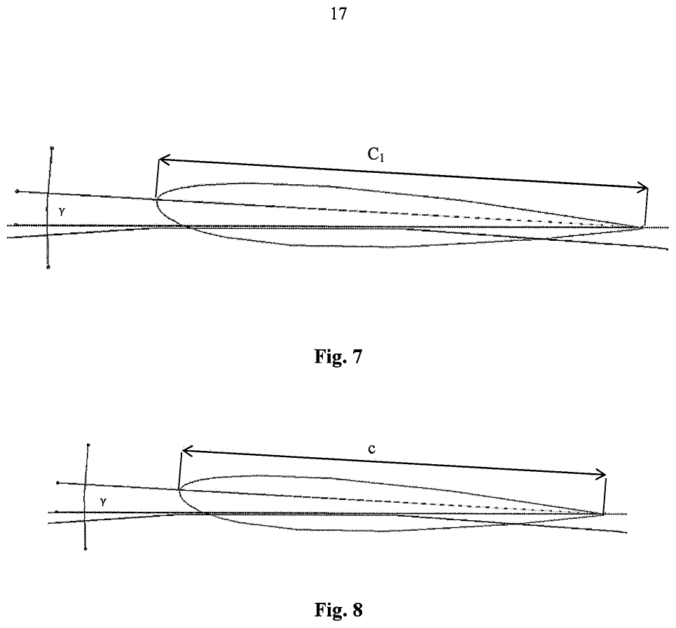

The wind turbine in its exemplary embodiment is shown in FIG. 1 presenting a front view of the wind turbine with two wing assemblies, FIG. 2 presenting a top view of the turbine from FIG. 1, and FIG. 3 presenting an isometric view of the turbine from FIG. 1. FIG. 4 shows a front view of the wind turbine with two wing assemblies; FIG. 5 is a top view of the wind turbine from FIG. 4 and FIG. 6 shows an isometric view of the turbine from FIG. 4, FIG. 7 is a view of the end of the wing of the lower assembly and FIG. 8 is a view W2 of the end of the wing of the subsequent assemblies.

As shown in FIG. 1, the turbine has two wings assemblies on the main shaft 1, the first wing assembly 2 with three wings 3 and a second wing assembly 4 with three wings 5. The wings 5 of the second assembly 4 are shifted in phase relative to the wings 3 of the first assembly 2 by a fixed angle of 60 degrees. The diameter “D₁” of the second assembly 4 of the wings 5 at half of its length is 1.15 of the diameter “d” at half of the length of the first lower assembly of the 2 wings 3.

FIG. 4 shows a turbine analogous to the turbine shown in FIG. 1, having two wing assemblies on the main shaft 1, the first wing assembly 2 with three wings 3 and the second wing assembly 4 with three wings 5, with the blades 3, 5 not parallel to the axis of rotation of the main shaft 1.

FIG. 7 and FIG. 8 show the wings 3, 5 of the assemblies 2, 4. Assembly 4 located above has a greater chord “C₁” of the wings 5 at half of their length than the chords “c” of the wings 3 of the lower assembly 2 at half of their length and those chords “C₁” at half of the length of the wings 5 of the upper assembly 4 are 1.15 of the length of the chord “c” at half of the length of the wings 3 of the lower assembly 2.

As shown, the wedging angle “y” of the wings 3, 5 between the wing chords and the tangent to the circle representing the path of the wings of the wind turbine 3, 5 is 3 degrees.

Furthermore, the aerodynamic sections of the biconvex wing profiles 3, 5 on the inner side of the chord line have width of 1.5 of the widths of the aerodynamic parts of the biconvex wing profiles outside of the chord line 3, 5.

What is claimed is:

1. A wind turbine with a vertical axis of rotation having more than one assembly of wings with aerodynamic profiles located on the main shaft of the power station, shifted in phase by a fixed angle, characterized in that the diameters of the assemblies/2,4/of the blades/3,5/change along with the height of their placement in such a way that the diameters/D_{i=1,2,3} . . . /at half of the length of each upper assembly/4/of the wings/5/are at least 1.05 of the diameter/d/at half of the length of the lowest assembly/2/of the blades/3/.

2. the wind turbine according to claim 1, characterized in that the assemblies/4/located above have greater chords/C_{i=1,2,3} . . . /of the blades/5/at half of their length from the chords/c/of the blades/3/of the lower assembly/2/at half of their length and that these chords/C_{i=1,2,3} . . . /at half of the length of the wings/5/of the assembly/4/located above are from 1.02 to 1.7 of the length of the chord/c/at half of the length of the wings/3/of the assembly/2/at the bottom, preferably from 1.1 to 1.3 of the chord/c/at half of the length of the wings/3/of the assembly/2/at the bottom.

3. the wind turbine according to claim 1 or 2 characterized in that the wedging angle/γ/of the wings/3, 5/is from 1 to 9 degrees, preferably from 2 to 5 degrees.

4. the wind turbine according to claim 1 or 2 or 3 characterized in that the that the sections of the aerodynamic biconvex wing profiles on the inner side of the chord line/3,5/have width from 1.05 to 2 of the width of the aerodynamic biconvex wing profiles on the outside from the chord line/c,C_{i=1,2,3} . . . /, preferably from 1.3 to 1.7 of the width of these aerodynamic biconvex wing profiles/3, 5/located on the outside from the chord line/c,C_{i=1,2,3} . . . /.
